(19) United States
(12) Patent Application Publication
(10) Pub. No.: US 2004/0004086 A1
(43) Pub. Date: Jan. 8, 2004

(54) Dispensing container with automatically shifting sliding element

(76) Inventors: Werner Muller Herrn, Frankfurt (DE); Karl Karch, Buttelborn (DE); Hermann Koch, Mainz (DE); Hans-Joachim Ploss, Kriftel (DE)

Correspondence Address: Finnegan, Henderson, Farabow,, Garrett & Dunner, L.L.P., 1300 I Street, N.W., Washington, DC, 20005-3315, US

(21) Appl. No.: 10/382,875

(22) Filed: Mar. 7, 2003

Related U.S. Application Data
(60) Provisional application No. 60/394,563, filed on Jul. 9, 2002.

(30) Foreign Application Priority Data
Mar. 8, 2002 (DE) 102 10 095.0

(51) Int. Cl. G01F 11/00

(52) U.S. Cl. 222/1; 206/528

(57) ABSTRACT

The invention relates to a dispensing container and a method of using the dispensing container that makes it possible to remove liquid, suspended, viscous or pasty contents from the container such that there is no excess of air within the container during storage and removal of the container contents and so that contact with the surrounding atmosphere is minimized. The dispensing container includes a hollow body, sealed at one end by a sliding element and at the other end by a membrane fastened on the hollow body. During the removal of the contents through the membrane, the sliding element is displaced toward the membrane by a vacuum generated by removal of some of the contents from the container.

### DESCRIPTION OF THE INVENTION

1. Field of the Invention

The invention relates to a dispensing container for introducing and removing liquid, suspended, viscous or pasty contents such that there is no excess of air contained in the container during storage and removal of the contents while minimizing contact with surrounding atmosphere. In particular, the container is to be used for introducing and removing protein-containing injection preparations or preparations of biotechnologically produced drugs.

2. Background of the Invention

There are many types of packaging used for liquid drug preparations. Multiple-dose bottles are one type of packaging that is used for liquid drug preparations, e.g., sterile insulin solutions or suspensions, the bottles containing an air space above the injection solution. When the injection solution is removed, e.g., by means of a syringe, non-sterile air is drawn into the bottle. It is also known to use, as packaging for drug preparations, cartridges which allow application of the drug preparations through the use of aids, e.g., pens. In this case, the piston stopper of the cartridge is pushed by means of a push rod, that is to say, by the application of direct mechanical force, in the direction of the outlet of the cartridge to which an injection needle has been fitted.

In the case of the multiple-dose bottles containing considerable amounts of air, it is possible, during transportation, storage, or during or after removal of the injection solutions, to observe changes in the injection solutions introduced into the bottles, e.g., particle formation, turbidity, discoloring etc., which signify a loss in stability of these injection solutions. According to instructions for using the drug, e.g., in the case of insulin preparations, an injection solution that has changed, e.g., become turbid, should not be used and should be disposed.

It is known that the stability of protein solutions can be drastically reduced by interaction with water-repellent surfaces such as liquid/air interfaces. It has thus been shown, using the example of insulin preparations, that the vibration of solutions that have been brought into contact with water-repellent surfaces results in denaturation/aggregation within a few hours, resulting in a drastic reduction in the insulin content of the solution. (Sluzky et. al.; Proc. Natl. Acad. Sci. USA; Vol.88; pp.9377-9381, November 1991, Applied Biological Sciences). In the absence of water-repellent surfaces, however, the solutions were stable even after having been vibrated for a number of days.

### SUMMARY OF THE INVENTION

Accordingly, the present invention is directed to developing a dispensing container that does not have the abovementioned disadvantages, i.e., a dispensing container which contains, for example, substantially no air space above the contents of the container, in order to stabilize the injection preparation.

According to one aspect of the present invention, a dispensing container is provided. The container comprises a hollow body that is sealed at one end by a sliding element and sealed at the opposite end by a membrane fastened onto the hollow body, the sliding element displaceable toward the membrane by air pressure acting on the sliding element when at least a portion of the contents in the container is removed through the membrane.

According to another aspect of the present invention, a method of removing contents from a dispensing container is provided. The method comprises providing a dispensing container comprising a hollow body that is sealed at one end by a sliding element and sealed at the opposite end by a membrane fastened onto the hollow body, the sliding element displaceable toward the membrane by air pressure acting on the sliding element, when at least a portion of the contents in the container is removed through the membrane, wherein the container contains contents to be dispersed, piercing the membrane with a removal system, transferring at least a portion of the contents in the container into the removal system, wherein the transferring generates a vacuum in the container, and automatically shifting the sliding element toward the membrane in response to the vacuum.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 is a cross-sectional view of a dispensing container according to one aspect of the present invention.

FIG. 2 is a cross-sectional view of the dispensing container of FIG. 1 in a partially emptied state.

### DESCRIPTION OF THE EMBODIMENT

Reference will now be made in detail to the present embodiment of the invention, an example of which is illustrated in the accompanying drawings. Wherever possible, the same reference numbers will be used throughout the drawings to refer to the same or like parts.

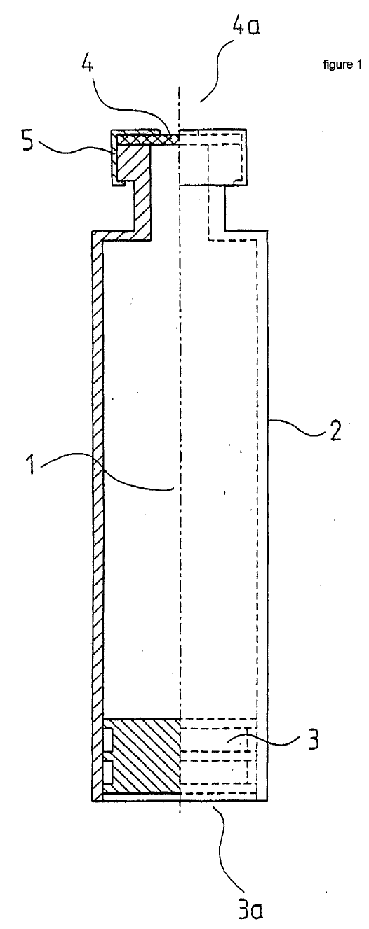

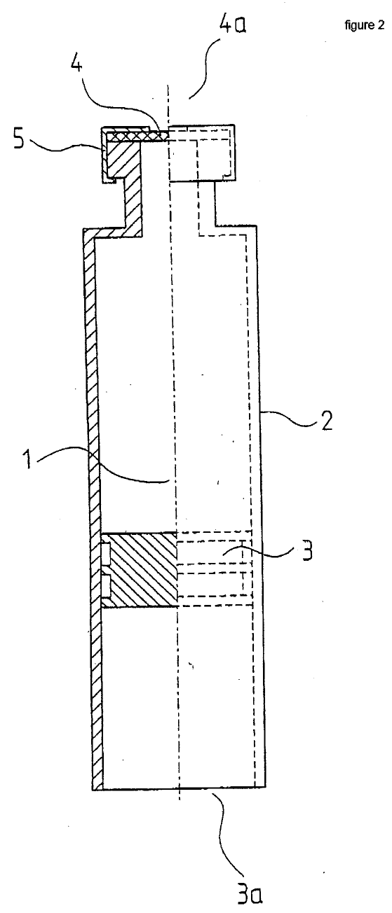

According to one aspect of the present invention, as shown in FIGS. 1-2, a hollow body (2) of a dispensing container (1) is closed at one end (3a) by a sliding element (3) and at the other end (4a) by a membrane (4). The sliding element (3) is movable within the hollow body (2) and along the length of the hollow body, toward the direction of the membrane end (4a) in response to negative pressure or vacuum generated within the container. The end (4a) is closed by a membrane (4) by means of a fastening system (5). The contents fill the dispensing container (1) without any significant excess of air. For removal of contents from the container by means of a removal system, the membrane (4) is pierced. As some of the contents are withdrawn from the container (1), the sliding element (3) shifts automatically in the direction of the end (4a). The sliding element (3) moves toward the membrane (4) for a distance that is proportional to the quantity of contents that is removed from container (1). No significant quantity of non-sterile air, if any at all, penetrates into the dispensing container.

The hollow body (2) is formed such that the sliding element (3) is movable in the container (1) towards end (4a) for a distance proportional to the quantity of content removed therefrom. The hollow body (2) may assume different cross-sectional shapes, e.g., round or polygonal with rounded corners, and is preferably round. The cross-sectional shape of the body (2) is constant over the entire useful length of the hollow body (2) to the extent where the sliding element (3) reliably closes the hollow body (2). The cross-sectional surface area, however, may be round over the full length of the hollow body (2). The line of movement of the sliding element (3) in the hollow body (2) need not necessarily be straight. Furthermore, the hollow body (2) may be formed from a wide range of different materials, e.g. glass, aluminum, etc., although glass is preferred. It is also possible, if appropriate, for the hollow body (2) to be designed to taper at the “membrane end” (4a).

The sliding element (3) may be formed from of a wide range of different materials, e.g., rubber, ceramic or plastic, and is preferably made of rubber. The sliding element (3) is formed such that—possibly once the hollow body (2) and/or sealing element has been treated correspondingly—it simultaneously slides freely in the hollow body (2) and, moreover, closes the hollow body (2) in a sealed manner. For this purpose, on the surface in which the sliding element (3) is in contact with the hollow body (2), the sliding element (3) includes an encircling sealing element (6), which seals the two elements, hollow body (2) and sliding element (3) in a form-fitting manner. It is possible for this sealing element (6) to be an integral constituent part of the sliding element (3) or, in addition, to be fitted thereon. Alternative sealing elements may include O-rings made of an elastic, sealing material, e.g., rubber or teflon. Particular examples of sliding elements (3) are piston stoppers or ceramic pistons, provided with a sealing element. A piston stopper made of rubber is particularly preferred.

The contents of the container (1) may be removed by piercing of the membrane (4) with a removal system. Suitable removal systems for removing the contents are, for example, syringes, e.g., disposable syringes with cannulas, non-filled ready-made syringes, insulin syringes, etc. The membrane (4) is capable of sealing itself again during and after removal. Suitable materials for the membrane (4) include elastic materials, e.g., rubber or plastic, and rubber is preferred.

The membrane (4) may be connected in a form-fitting manner to the hollow body (2) by different fastening systems (5), e.g., by means of a flanged cap, a union nut, or by adhesive bonding. The flanged cap (5), e.g., as shown in FIGS. 1-2, is preferred.

The size of the dispensing container (1) can vary greatly. It depends on the desired quantity of contents and may comprise, for example, volume ranges of from about 1 to about 250 ml, for example about 1.5 ml, about 1.7 ml, about 3 ml, about 5 ml, about 10 ml, about 20 ml, about 50 ml. Larger or smaller volumes may also be used. Dispensing containers (1) between about 5 ml to about 20 ml are preferred, with a volume of about 10 ml being especially preferred.

Suitable contents of the dispenser (1) include all liquid, suspended, viscous or pasty materials, e.g., solutions or suspensions, preferably protein-containing preparations or preparations of biotechnologically produced drugs. Insulins, insulin analogs, growth hormones or antithrombotics are preferred, with insulins and their analogs being especially preferred.

### EXAMPLES

The physical stabilization of contents contained in this dispenser container (1) was examined, by way of example, using an insulin preparation of acid pH. For this purpose, use was made of a vibration test, an established method of investigating insulin aggregation after being affected by physical stress (V. Feingold et. al., Diabetologia (1984), 27,373-378).

In the case of the test system used, the insulin preparation to be investigated was introduced into two glass vessels with a volume of 2 ml (HPLC bottles), in the first instance without any excess of air and in the second instance with an amount of air in excess of 100 μl. The purpose was to simulate, in the first instance, a completely sealed dispensing container (1) without any excess of air, and, in the second instance, the air volume within a normal multiple-dose bottle.

The bottles were inserted into a bottle holder and fixed in a specifically designed vibration system and subjected to loading at 37° C. (thermal loading), a frequency of 40 Hz and displacement of 20G (mechanical loading). The vibration was produced by a type of loudspeaker diaphragm coupled to an amplifier with a frequency and displacement regulator. The period of time over which the insulin preparation remains clear may be regarded as a measure of the physical stability of insulin preparations, turbidity setting in thereafter, e.g., as a result of aggregation (V. Feingold et. al.). For measuring the turbidity, the bottles were removed from the test system at different times and the degree of turbidity was investigated.

### Example 1

In Test 1, using three batches of an insulin preparation with an acid pH, each batch containing three bottles filled without an air space and three bottles filled with an air space of 100 μl, each of the bottles was investigated by means of the above vibration system. While all the bottles in the three batches with an excess of air showed considerable turbidity after 24 hours, all the bottles in the three batches without an excess of air showed no turbidity even after 168 hours (the testing ceased thereafter) and thus were stable.

In order for it to be possible for the progression of the turbidity of the batches over time to be assessed to better effect, the time intervals between the measurements were shortened in a second test.

### Example 2

Six batches were investigated in Test 2. Five of these batches were incubated with an excess of air of 100 μl and one batch was incubated without an excess of air. While the batches with an excess of air showed increasingly pronounced turbidity within three (3) hours, the batches without an excess of air were stable for at least 209 hours and showed no turbidity (the testing ceased thereafter).

Test 1 and Test 2 demonstrate that a multiple-dose bottle without an air space has a stabilizing effect on protein-containing preparations, in particular insulin preparations.

### Example 3

Test 3 was carried out in order to demonstrate the stability of the preparation, with and without an air space, during the removal process. It was found that, as a result of simulated removal from a multiple-dose vessel by means of a syringe, slight turbidity may occur if an air space is contained within the vessel. The removal operation was simulated by piercing the membrane daily using a needle, although contents were not removed in the process. A comparative test using an insulin preparation with an acid pH in 10 ml multiple-dose bottles, with and without an air space, showed that slight turbidity was evident after approximately 23 days for the bottle with an air space, while the bottle without an air space did not display any turbidity even after 50 days (the testing ceased thereafter).

These results clearly demonstrate that, by using the dispensing container according to the present invention, the stability of the preparation contained therein—in contrast to the known dispensing containers with an air space—was increased to a considerable extent.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A dispensing container comprising:
a hollow body sealed at one end by a sliding element and sealed at the opposite end by a membrane fastened onto the hollow body, the sliding element displaceable toward the membrane by air pressure acting on the sliding element when at least a portion of a content in the container is removed through the membrane.

2. The dispensing container of claim 1, wherein the hollow body has a round cross-sectional shape.

3. The dispensing container of claim 1, wherein the hollow body is made of glass.

4. The dispensing container of claim 1, wherein the hollow body tapers at the membrane end.

5. The dispensing container of claim 1, wherein the sliding element is a piston.

6. The dispensing container of claim 5, wherein the sliding element is made of rubber.

7. The dispensing container of claim 5, wherein the sliding element is made of ceramic.

8. The dispensing container of claim 1, wherein the membrane is made of rubber.

9. The dispensing container of claim 1, wherein the membrane is connected to the hollow body by a flanged cap.

10. The dispensing container of claim 1, wherein the container contains insulin and its analogs.

11. The dispensing container of claim 1, further comprising a sealing element that surrounds the sliding element.

12. The dispensing container of claim 11, wherein the sealing element is an O-ring.

13. The dispensing container of claim 11, wherein the sealing element is made of rubber or teflon.

14. The dispensing container of claim 1, wherein the membrane is self-resealing.

15. A method of removing contents from a dispensing container comprising:
providing a dispensing container comprising a hollow body sealed at one end by a sliding element and sealed at the opposite end by a membrane fastened onto the hollow body, the sliding element displaceable toward the membrane by an air pressure acting on the sliding element when at least a portion of the contents in the container is removed through the membrane, wherein the container contains contents to be dispersed;
piercing the membrane with a removal system;
transferring at least a portion of the contents in the container into the removal system, wherein the transferring generates a vacuum within the container; and
automatically shifting the sliding element toward the membrane in response to the vacuum.

16. The method of claim 15, wherein the removal system is a syringe.

17. The method of claim 15, wherein the sliding element automatically shifts toward the membrane a distance proportional to the quantity of solution removed.

18. A method of removing contents from a dispensing container comprising:
providing a dispensing container comprising a hollow body sealed at one end by a sliding element and sealed at the opposite end by a membrane fastened onto the hollow body, the sliding element displaceable toward the membrane by an air pressure acting on the sliding element when at least a portion of the contents in the container is removed through the membrane, wherein the container contains contents to be dispersed;
piercing the membrane with a removal system;
transferring at least a portion of the contents in the container into the removal system, wherein the transferring generates an air pressure; and
automatically shifting the sliding element toward the membrane in response to the generated air pressure.

19. The method of claim 18, wherein the air pressure is a negative pressure.

20. The method of claim 18, wherein the air pressure is a vacuum.
